(19) United States
(12) Patent Application Publication
(10) Pub. No.: US 2009/0044400 A1
(43) Pub. Date: Feb. 19, 2009

(54) CABLE MARKER PLACEMENT TOOL AND METHOD

(75) Inventors: Bradley Robert Kokoski, Fort Mill, SC (US); Steven Jay Hahn, Lake Wylie, SC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: MACLEAN JAMESON, L.L.C., Clover, SC (US)

(21) Appl. No.: 11/839,918

(22) Filed: Aug. 16, 2007

(51) Int. Cl. H01B 7/36; H01B 13/34

(52) U.S. Cl. 29/728

(57) ABSTRACT

An apparatus for lifting and applying a rolled, tubular aerial cable marker to a cable, including a support, a top holding bar carried by the support for receiving and retaining a top end of a cable marker roll in an at least partially unrolled, tensioned condition, and for positioning and releasing the top end of the cable marker onto the cable. A bottom holding bar is carried by the support and retains a bottom end of the rolled cable marker, and releases the bottom end of the cable marker onto the cable, thereby allowing the cable marker to return to its initial, rolled tubular shape in position around the cable. A related method is also disclosed.

### TECHNICAL FIELD AND BACKGROUND OF THE INVENTION

This invention relates to the field of aerial cable installations, including devices and methods for accessing overhead cables from the ground using poles. More particularly, the invention disclosed and claimed herein relates to overhead cable markers, and specifically to tubular cable markers of the type that can be unrolled from their normal tubular configuration for installation. The increase in aerial cable installations, as well as the ongoing creation, consolidation and buyout of telecommunication and cable television companies creates problems in keeping track of which overhead cables are owned and maintained by a particular utility company at any given time. To resolve problems of this type, many state and local utility regulatory councils have adopted standards for marking overhead cables in a manner that permits ownership or responsibility for the cable to be reliably determined. Some of the marking products are, for example, “clip-on” types of overhead tags or markers that are applied directly to the cable. These marking products are typically applied manually to the cables by service technicians working from aerial lift buckets mounted on the end of a boom carried by a utility truck. This practice, of course, is very expensive and time-consuming unless done at the same time with other service or installation work on the same or nearby cables. For this reason, there exists a need for an inexpensive and easy-to-use product and method for applying identification markers to overhead cables.

A simpler, faster, more cost efficient and safer way of installing the roll-up type marker is to do so from the ground through use of an extension pole and attached tool to secure and attach the marker.

### SUMMARY OF THE INVENTION

Therefore, it is an object of the invention to provide a product and method for applying identification markers to overhead cables.

It is another object of the invention to provide a product and method for applying identification markers to overhead cables that is inexpensive and easy-to-use.

It is another object of the invention to provide a product and method for applying identification markers to overhead cables that can be performed from the ground, therefore avoiding the necessity of using an aerial lift bucket truck.

These and other objects and advantages of the invention are achieved by providing an apparatus for lifting and applying a rolled, tubular aerial cable marker to a cable, comprising a support, a top holding bar carried by the support for receiving and retaining a top end of a cable marker roll in an at least partially unrolled, tensioned condition, and for positioning and releasing the top end of the cable marker onto the cable, and a bottom holding bar carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable.

According to one embodiment of the invention, the support includes a mounting device for mounting the support on a pole.

According to another embodiment of the invention the support includes a handle for being inserted into and held in place in a tube carried on the end of a pole.

According to yet another embodiment of the invention, the bottom holding bar includes an inverted tab for retaining and releasing the bottom end of the rolled cable marker.

According to yet another embodiment of the invention the bottom holding bar includes an adjusting device for allowing the distance between the top holding bar and the bottom holding bar to be adjusted to properly accommodate the length of the cable marker in its at least partially unrolled, tensioned condition.

According to yet another embodiment of the invention, the bottom holding bar is mounted generally parallel and laterally offset in relation to the support, and includes an adjusting device comprising a slide member positioned on the holding bar and mounted for sliding spaced-apart adjustment in relation to the top holding bar to accommodate the length of the cable marker in its at least partially unrolled, tensioned condition.

According to yet another embodiment of the invention, the adjusting device includes a set screw threaded through the side of the slide member for locking the slide member in a desired position along the length of the bottom holding bar.

According to yet another embodiment of the invention, the top holding bar is positioned perpendicular and laterally offset in relation to the support to provide a clearance between the top holding bar and the support when positioning and releasing the top end of the cable marker onto the cable.

According to yet another embodiment of the invention, an apparatus is provided for lifting and applying a rolled, tubular aerial cable marker to a cable, comprising a support, including a mounting device for mounting the support on a pole, and a top holding bar carried by the support for receiving and retaining a top end of a cable marker roll in an at least partially unrolled, tensioned condition, and for positioning and releasing the top end of the cable marker onto the cable. The top bar is positioned perpendicular and laterally offset in relation to the support to provide a clearance between the top holding bar and the support when positioning and releasing the top end of the cable marker onto the cable. A bottom holding bar is carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable. An adjusting device is mounted on the bottom holding bar for allowing the distance between the top holding bar and the bottom holding bar to be adjusted to properly accommodate the length of the cable marker in its at least partially unrolled, tensioned condition.

According to yet another embodiment of the invention, the support includes a handle for being inserted into and held in place in a tube carried on the end of a pole.

According to yet another embodiment of the invention, the adjusting device includes a set screw threaded through the side of the member for locking the slide member in a desired position along the length of the bottom holding bar.

According to yet another embodiment of the invention, a method of lifting and applying a rolled, tubular aerial cable marker to a cable is provided, comprising the steps of providing a support, a top holding bar carried by the support for receiving and retaining a top end of a cable marker roll in an at least partially unrolled, tensioned condition, and for positioning and releasing the top end of the cable marker onto the cable; and a bottom holding bar carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable.

The cable marker is placed in its rolled condition onto the top holding bar, and the cable marker is at least partially unrolled. A bottom end of the cable marker is connected onto the bottom holding bar and the top holding bar is moved to the cable.

The marker is positioned on the top holding bar with pressure against the cable, and the top holding bar is lowered to allow the marker on the top holding bar to slip from the top holding bar and clip onto the cable. The support is raised to allow the marker to roll itself into its rolled condition on the cable, and the bottom holding bar is released from the bottom of the cable marker.

According to yet another embodiment of the invention, the method includes the step of adjusting the distance between the top holding bar and bottom holding bar to properly accommodate the length of the cable marker in its at least partially unrolled, tensioned condition.

According to yet another embodiment of the invention, the method includes the step of mounting the support on the end of a pole.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of an apparatus for lifting and applying a rolled, tubular aerial cable marker to a cable according to one embodiment of the invention; and

FIGS. 2-7 are sequential views showing installation of a tubular cable marker using the apparatus of FIG. 1.

### DESCRIPTION OF THE PREFERRED EMBODIMENTS AND BEST MODE

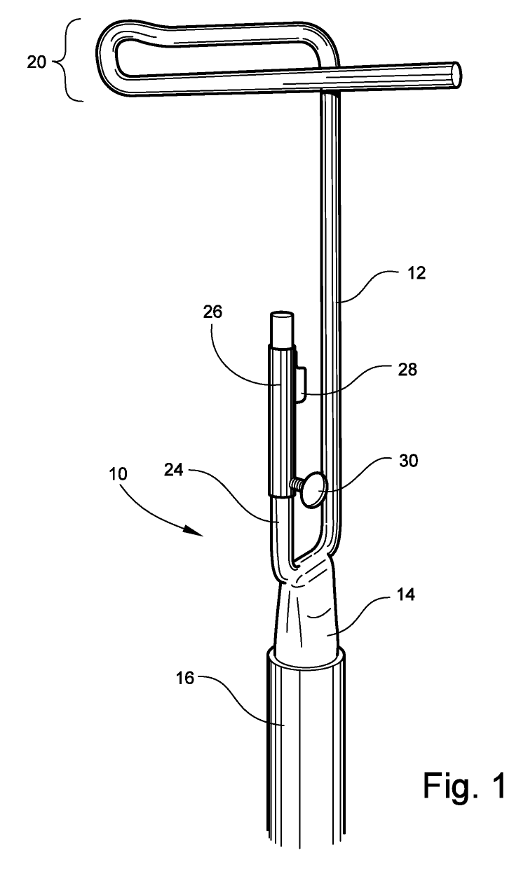

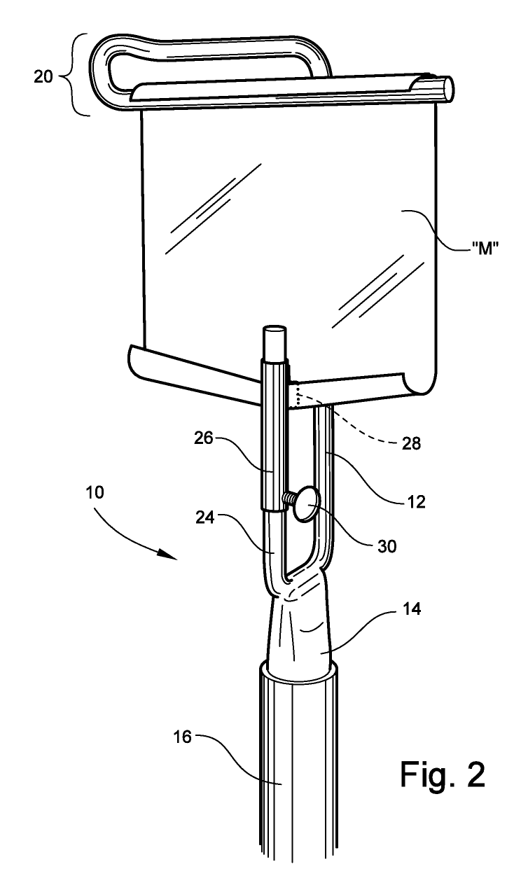

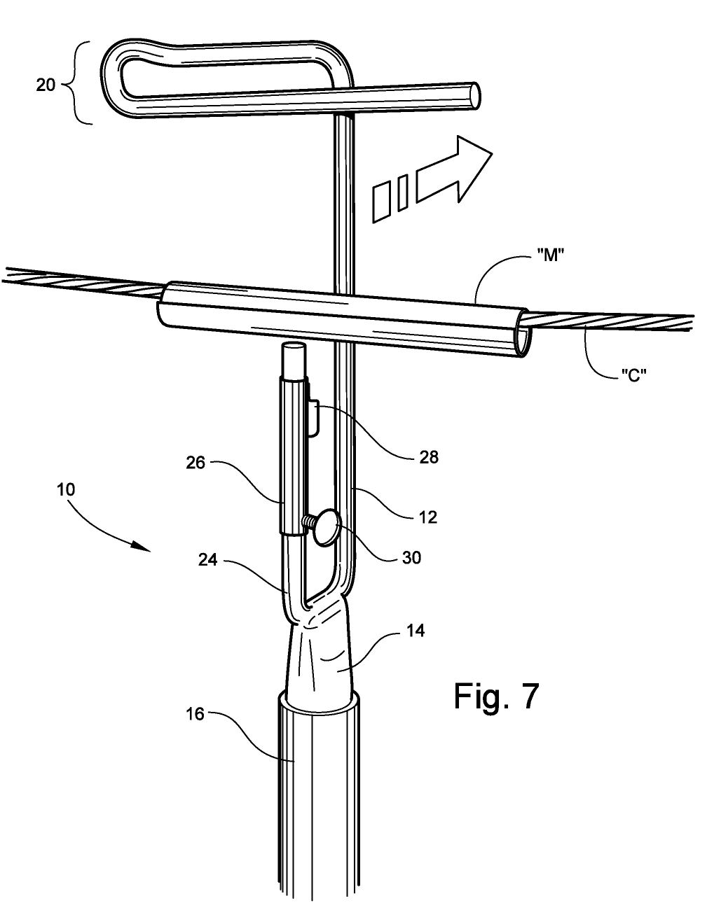

Referring now specifically to the drawings, an apparatus for lifting and applying a rolled, tubular aerial cable marker to a cable “M” according to the present invention is shown generally in FIGS. 1-7 at reference numeral 10. The apparatus 10 includes a support bar 12 mounted on a handle 14 for being inserted into and held in place in a tube 16 carried on the end of a pole, not shown. A top holding bar 20 carried by the support bar 12 is provided for receiving and retaining a top end of a tubular cable marker “M”, as shown in FIGS. 2-7, in an at least partially unrolled, tensioned condition, and for positioning and releasing the top end of the cable marker “M” onto the cable “C.”

A bottom holding bar 24 is carried by the support bar 12 in spaced-apart relation to the top holding bar 20 for receiving and retaining a bottom end of the rolled cable marker “M”, and for releasing the bottom end of the cable marker “M” onto the cable “C”, thereby allowing the cable marker “M” to return to its initial, rolled tubular shape in position around the cable “C”.

The bottom holding bar 24 includes an adjusting device, such as a tubular slide member 26 positioned on the bottom holding bar 24 and mounted for sliding spaced-apart adjustment in relation to the top holding bar 20 in order to accommodate the length of the cable marker “M” in its at least partially unrolled, tensioned condition. The bottom holding bar 24 also includes an inverted tab 28 mounted on the slide member 26 for retaining and releasing the bottom end of the rolled cable marker “M”. The slide member includes a set screw 30 threaded through the side of the slide member 26 for locking the slide member in a desired position along the length of the bottom holding bar 24. In the preferred embodiment described in this application, the support bar 12, top holding bar 20 and bottom holding bar 24 are formed from a single length of steel round bar stock that is welded to the handle 14 between the support bar 12 and the bottom holding bar 24. However, the use of other metals, for example, aluminum, or other materials, such as plastic, fiberglass, or carbon fiber resins is within the scope of this application, as are differing fabrication methods, such as injection molding, stamping and assembly from separate pieces.

The top holding bar 20 is positioned perpendicular and laterally offset in relation to the support bar 12 in order to provide a clearance between the top holding bar 20 and the support bar 12 when positioning and releasing the top end of the cable marker “M” onto the cable “C”.

Referring now specifically to FIGS. 2-7, a method of lifting and applying tubular aerial cable marker “M” to the cable “C” is illustrated. The cable marker “M” is typically a paper or plastic sheet having a distinctive color and/or identifying information thereon that is formed into a tight tube, which is its normal condition when not under tension. To begin the installation process, the cable marker “M” in its rolled condition is slid onto the free end of the top holding bar 20. The cable marker “M” is at least partially unrolled, as shown in FIG. 2. As is also shown in FIG. 2, the cable marker “M” is attached to the bottom end of the cable marker “M” onto the bottom holding bar by placing the partially curled end of the cable marker “M” under the inverted tab 28. The tension on the cable marker “M” holds the cable marker “M” in place under the inverted tab 28.

If necessary, the distance between the top holding bar 20 and the inverted tab 28 on the bottom holding bar 24 is adjusted by loosening the set screw 30, sliding the slide member 26 to the correct location, and then tightening the set screw 30.

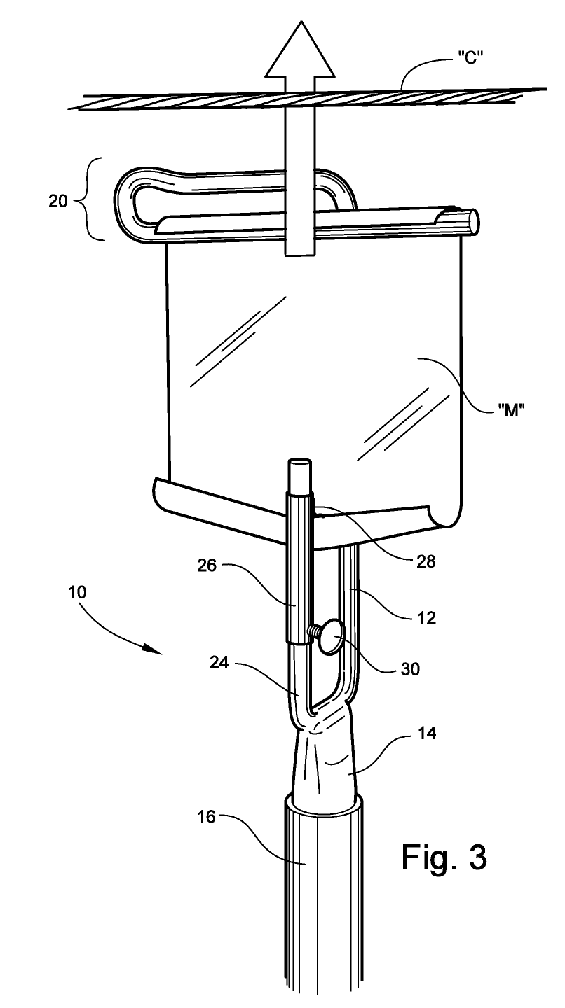

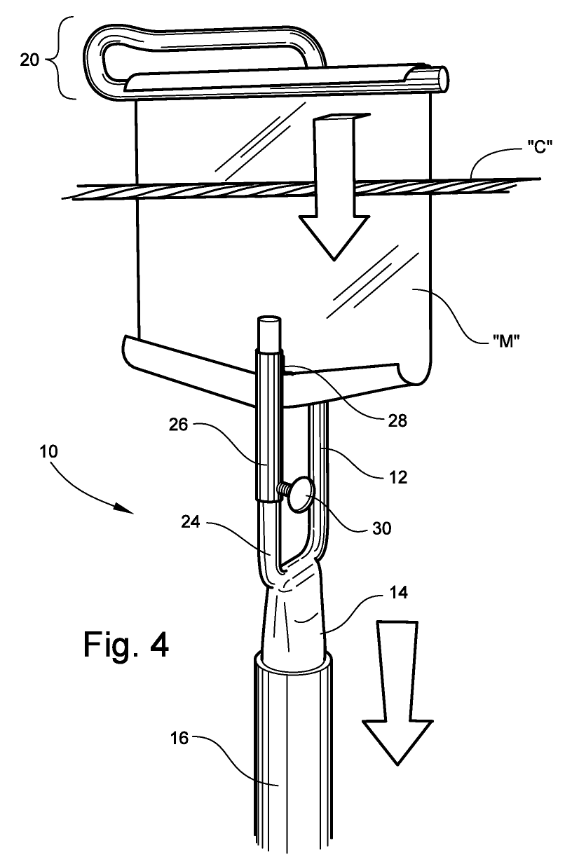

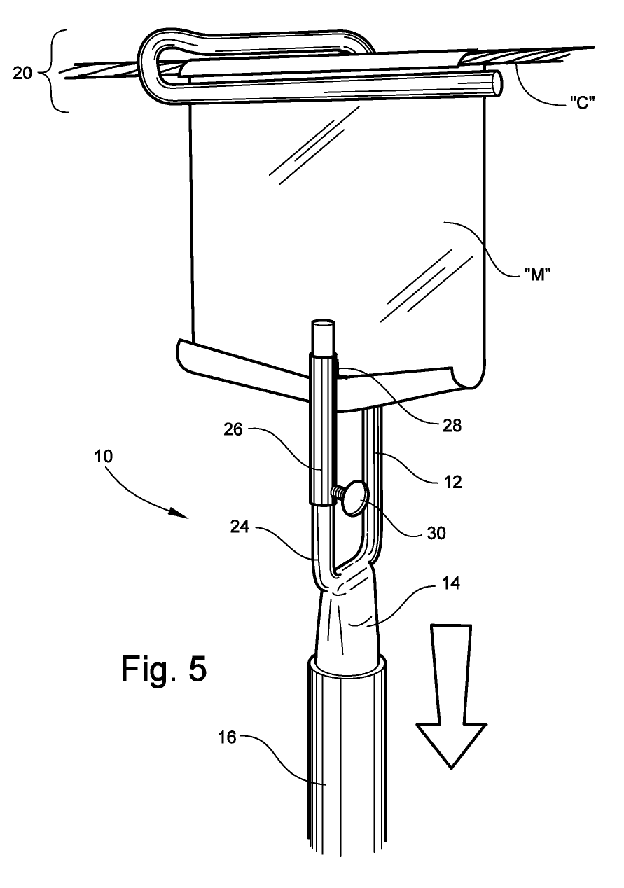

As is shown in FIG. 3, the apparatus 10 is lifted up so that the top holding bar 20 is above the cable “C”, with the marker “M” held with pressure against the cable “C”. Referring to FIGS. 4 and 5, the top holding bar 20 is lowered with the marker “M” touching the cable “C” to allow the marker “M” on the top holding bar 20 to slip from the top holding bar 20 and clip onto the cable “C”.

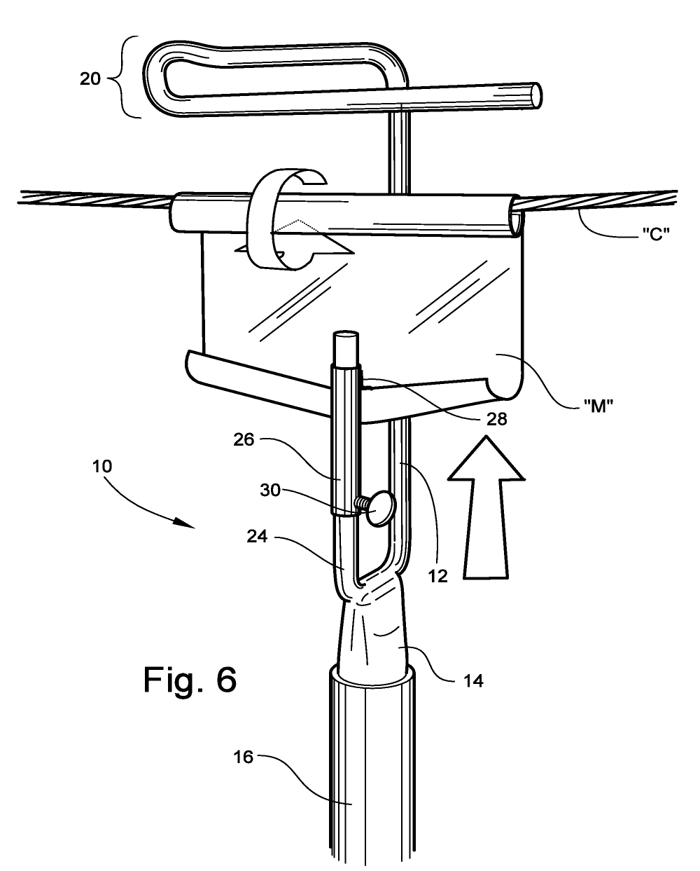

As shown in FIG. 6, the apparatus 10 is raised to allow the marker “M” to roll itself into its rolled condition on the cable “C” and to allow the cable marker “M” to slip from under the inverted tab 28, thus releasing the bottom holding bar 24 from the bottom of the cable marker “M”. The apparatus 10 is then moved laterally away from the cable “C” and lowered, leaving the cable marker “M” securely positioned on the cable “C.”

An apparatus for lifting and applying a rolled, tubular aerial cable marker to a cable is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

We claim:

1. An apparatus for lifting and applying a rolled, tubular aerial cable marker to a cable, comprising:
(a) a support;
(b) a top holding bar carried by the support for receiving and retaining a top end of a cable marker roll in an at least partially unrolled, tensioned condition, and for positioning and releasing the top end of the cable marker onto the cable; and
(c) a bottom holding bar carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable.

2. An apparatus according to claim 1, wherein the support includes a mounting device for mounting the support on a pole.

3. An apparatus according to claim 1, wherein the support includes a handle for being inserted into and held in place in a tube carried on the end of a pole.

4. An apparatus according to claim 1, wherein the bottom holding bar includes an inverted tab for retaining and releasing the bottom end of the rolled cable marker.

5. An apparatus according to claim 1, wherein the bottom holding bar includes an adjusting device for allowing the distance between the top holding bar and the bottom holding bar to be adjusted to properly accommodate the length of the cable marker in its at least partially unrolled, tensioned condition.

6. An apparatus according to claim 1, wherein the bottom holding bar is mounted generally parallel and laterally offset in relation to the support, and includes an adjusting device comprising a slide member positioned on the holding bar and mounted for sliding spaced-apart adjustment in relation to the top holding bar to accommodate the length of the cable marker in its at least partially unrolled, tensioned condition.

7. An apparatus according to claim 5, wherein the adjusting device includes a set screw threaded through the side of the slide member for locking the slide member in a desired position along the length of the bottom holding bar.

8. An apparatus according to claim 1, wherein the top holding bar is positioned perpendicular and laterally offset in relation to the support to provide a clearance between the top holding bar and the support when positioning and releasing the top end of the cable marker onto the cable.

9. An apparatus for lifting and applying a rolled, tubular aerial cable marker to a cable, comprising:
(a) a support, including a mounting device for mounting the support on a pole;
(b) a top holding bar carried by the support for receiving and retaining a top end of a cable marker roll in an at least partially unrolled, tensioned condition, and for positioning and releasing the top end of the cable marker onto the cable, the top bar being positioned perpendicular and laterally offset in relation to the support to provide a clearance between the top holding bar and the support when positioning and releasing the top end of the cable marker onto the cable; and
(c) a bottom holding bar carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable: and
(d) an adjusting device mounted on the bottom holding bar for allowing the distance between the top holding bar and the bottom holding bar to be adjusted to properly accommodate the length of the cable marker in its at least partially unrolled, tensioned condition.

10. An apparatus according to claim 9, wherein the support includes a handle for being inserted into and held in place in a tube carried on the end of a pole.

11. An apparatus according to claim 9, wherein the adjusting device includes a set screw threaded through the side of the member for locking the slide member in a desired position along the length of the bottom holding bar.

12. A method of lifting and applying a rolled, tubular aerial cable marker to a cable, comprising the steps of:
(a) providing:
(i) a support;
(ii) a top holding bar carried by the support for receiving and retaining a top end of a cable marker roll in an at least partially unrolled, tensioned condition, and for positioning and releasing the top end of the cable marker onto the cable; and
(iii) a bottom holding bar carried by the support in spaced-apart relation to the top holding bar for receiving and retaining a bottom end of the rolled cable marker, and for releasing the bottom end of the cable marker onto the cable, thereby allowing the cable marker to return to its initial, rolled tubular shape in position around the cable;
(b) placing the cable marker in its rolled condition onto the top holding bar:
(c) at least partially unrolling the cable marker;
(d) attaching a bottom end of the cable marker onto the bottom holding bar;
(e) moving the top holding bar to the cable;
(f) positioning the marker on the top holding bar with pressure against the cable;
(g) lowering the top holding bar to allow the marker on the top holding bar to slip from the top holding bar and clip onto the cable;
(h) raising the support to allow the marker to roll itself into its rolled condition on the cable; and
(i) releasing the bottom holding bar from the bottom of the cable marker.

13. A method according to claim 12, and including the step of adjusting the distance between the top holding bar and bottom holding bar to properly accommodate the length of the cable marker in its at least partially unrolled, tensioned condition.

14. A method according to claim 12, and including the step of mounting the support on the end of a pole.
